(19) United States
(12) Patent Application Publication
(10) Pub. No.: US 2017/0351263 A1
(43) Pub. Date: Dec. 7, 2017

(54) Roadway-Infrastructure-Maintenance System Using Automated Vehicles

(71) Applicant: Delphi Technologies, Inc., Troy, MI (US)

(72) Inventors: Serge Lambermont, Singapore (SG); Jong Ho Lee, Pittsburgh, PA (US); Gaurav Bhatia, Pittsburgh, PA (US); Glen W. De Vos, Grand Blanc, MI (US)

(21) Appl. No.: 15/171,129

(22) Filed: Jun. 2, 2016

(51) Int. Cl. G05D 1/02; G06K 9/00; G05D 1/00; H04N 7/18

(52) U.S. Cl. CPC G05D 1/0246; H04N 7/183; G06K 9/00818; G06K 9/00798; G05D 1/0088; G06K 9/00791; G05D 1/0257; G05D 1/0248; G05D 2201/0207

(57) ABSTRACT

A roadway-infrastructure-maintenance system using automated-vehicles to maintain a roadway includes an image-device and a controller. The imaging-device is suitable to mount on a host-vehicle. The imaging-device is used to detect an infrastructure-feature proximate to a roadway traveled by the host-vehicle. The controller is in communication with the imaging-device. The controller is configured to determine a need-for-maintenance of the infrastructure-feature. The system may include a digital-map that indicates an expected-presence of the infrastructure-feature, and the need-for-maintenance may be indicated when the infrastructure-feature is not-detected as expected. The system may also include a transmitter in communication with the controller. The transmitter may be used to communicate the need-for-maintenance to a maintenance-organization.

### TECHNICAL FIELD OF INVENTION

This disclosure generally relates to a roadway-infrastructure-maintenance system using automated-vehicles, and more particularly relates to a system configured to determine a need-for-maintenance of the infrastructure-feature.

### BACKGROUND OF INVENTION

It is known that an automated-vehicle detects infrastructure-features such as lane-markings, light-color emitted by a traffic-signal, and roadway-signs in order to determine how the automated-vehicle, i.e. a self-driving vehicle, should be operated. For example, the automated-vehicle travels through an intersection when the traffic-signal is green, and the automated-vehicle stops when the traffic-signal is red. Furthermore, consistent and visible lane-markings are particularly helpful to operate an automated-vehicle. However, normal wear, aging, and/or damage by a natural disaster or a collision with a vehicle may make it difficult or impossible for an infrastructure-feature to be detected.

### SUMMARY OF THE INVENTION

In accordance with one embodiment, a roadway-infrastructure-maintenance system using automated-vehicles to maintain a roadway is provided. The system includes an image-device and a controller. The imaging-device is suitable to mount on a host-vehicle. The imaging-device is used to detect an infrastructure-feature proximate to a roadway traveled by the host-vehicle. The controller is in communication with the imaging-device. The controller is configured to determine a need-for-maintenance of the infrastructure-feature.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a diagram of a map-data update system in accordance with one embodiment; and

FIG. 2 is a traffic scenario encountered by the system of FIG. 1 in accordance with one embodiment.

### DETAILED DESCRIPTION

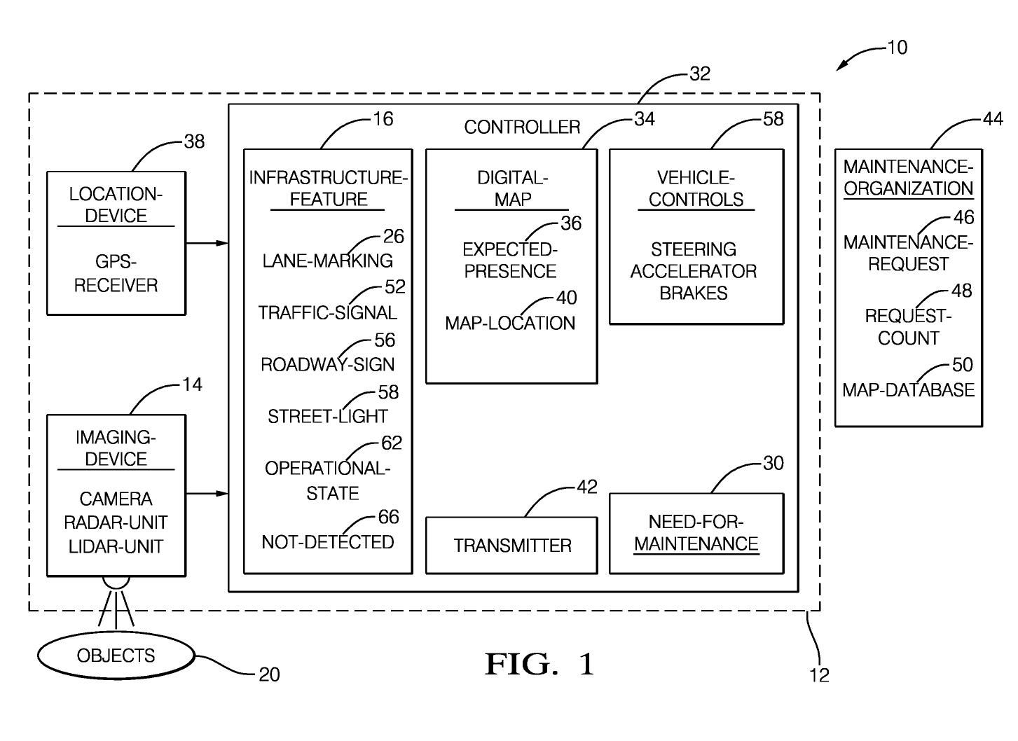

FIG. 1 illustrates a non-limiting example of a roadway-infrastructure-maintenance system, hereafter referred to as the system 10. As will be explained in more detail below, the system 10 makes use of the object-detections abilities found in most examples of autonomous or automated-vehicles, in this case represented by a host-vehicle 12. The system 10 uses those abilities to help identify instances of infrastructure-features such as lane-markings, traffic-signals, roadway-signs, and/or street-lights in need of repair and thereby help to maintain a roadway. In one embodiment, the host-vehicle 12 is characterized as an automated-taxi (not shown). That is, driverless vehicles that do not have operator controls may be used to search for instance where infrastructure-features are in need of maintenance, including, but not limited to, determining that snow-removal services are needed.

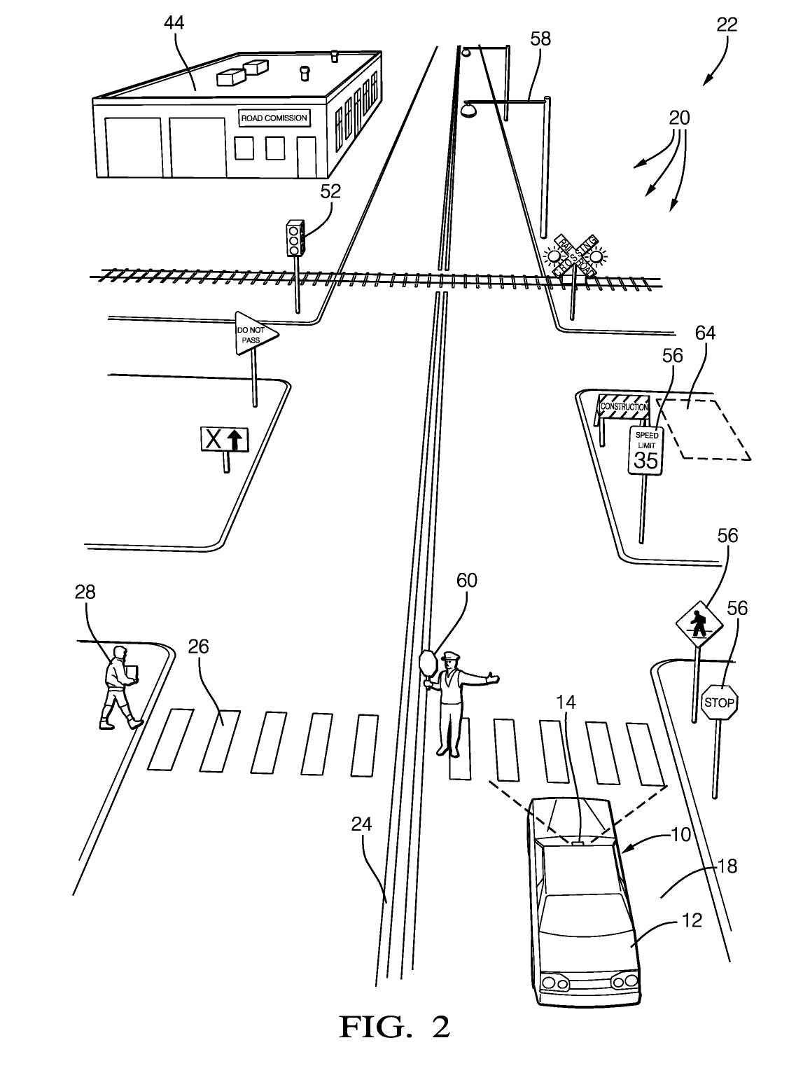

The system 10 includes an imaging-device 14 suitable to mount on the host-vehicle 12. In general, the imaging-device 14 is used to detect one or more instances of objects 20 proximate to a roadway 18 (FIG. 2) traveled by the host-vehicle 12. The system 10 determines which of the objects 20 may be an infrastructure-feature 16. By way of example and not limitation, the imaging-device 14 may include any one or any combination of a camera, a radar-unit, and a lidar-unit, or any other device suitable to detect the objects 20 proximate the roadway 18 that are an instance of the infrastructure-feature 16 and may be in need of maintenance.

FIG. 2 illustrates a non-limiting example of a traffic-scenario 22 encountered by the host-vehicle 12. One non-limiting example of the infrastructure-feature 16 is a lane-marking 24 which may be used by the system 10 as a guide by which the system 10 steers the host-vehicle 12 via the vehicle-controls 58 (FIG. 1) of the host-vehicle 12. The lane-marking 24 is typically formed of paint that includes light reflective characteristics that make the lane-marking 24 readily detectable using the camera and or the lidar-unit of the imaging-device 14. A crosswalk-marking 26 may also be detected by the imaging-device 14, and the presence of the crosswalk-marking 26 may be used by the system 10 to search for and more readily identify the presence of, for example, a pedestrian 28 and/or a crossing-guard 60. That is, because the presence of the crosswalk-marking 26 is detected, the identification and/or classification of the objects 20 can be more reliably performed because the object-identification algorithms can be tuned or selected to more readily identify the pedestrian 28 and/or the crossing-guard 60.

Because the quality of the lane-marking 24 and the crosswalk-marking 26 is important to the operation of the host-vehicle 12, the system 10 advantageously is configured to evaluate the quality of the lane-marking 24 and the crosswalk-marking 26, and determine when there is a need-for-maintenance 30 of the infrastructure-feature 16, in this example the lane-marking 24 and the crosswalk-marking 26.

Accordingly, the system 10 includes a controller 32 in communication with the imaging-device 14. The controller 32 may include a processor (not specifically shown) such as a microprocessor or other control circuitry such as analog and/or digital control circuitry including an application specific integrated circuit (ASIC) for processing data as should be evident to those in the art. The controller 32 may include memory (not specifically shown), including non-volatile memory, such as electrically erasable programmable read-only memory (EEPROM) for storing one or more routines, thresholds, and captured data. The one or more routines may be executed by the processor to perform steps for determining when the infrastructure-feature 16 exhibit's the need-for-maintenance 30 based on signals received by the controller 32 from the imaging-device 14 as described herein.

In order for the system 10 to more readily detect the presence of an instance of the infrastructure-feature 16, the system 10 or more particularly the controller 32 may include a digital-map 34 that indicates an expected-presence 36 of the infrastructure-feature 16. The system 10 may include a location-device 38 such as a global-positioning-system-receiver (GPS-receiver) so that a map-location 40 on the digital-map 34 can be determined. If the system 10 or the controller 32 is unable to or has difficulty detecting the expected-presence 36 of the infrastructure-feature 16 at the map-location 40, then that may be an indication that the need-for-maintenance 30 is indicated when the infrastructure-feature 16 is not-detected as expected. For example, if the lane-marking 24 and/or the crosswalk-marking 26 are not detected or do not appear with sufficient contrast to the surface of the roadway 18, then that may be in indication of the need-for-maintenance 30. The cause may be that the paint used for the lane-marking 24 and/or the crosswalk-marking 26 is worn, or they may be covered by ice, snow, mud, or other debris that should be removed.

In order for the system 10 to communicate the need-for-maintenance, the system 10 includes a transmitter 42 in communication with the controller 32. The transmitter 42 may be used to communicate the need-for-maintenance 30 to a maintenance-organization 44 such a county road-commission or other suitable government agency, which may eventually lead to a maintenance-request 46 being issued by the maintenance-organization 44 to dispatch the necessary persons and/or equipment to address the need-for-maintenance 30. In order to prevent spoofing or malicious activity that wastes the resources of the maintenance-organization 44, the maintenance-request 46 may not be issued until a request-count 48 is greater than some threshold, greater than five for example, arising from multiple instances of the need-for-maintenance 30 for the same infrastructure-feature 16 being received. The maintenance-organization 44 may also maintain a map-database 50 which may be used to periodically update the digital-map 34.

By way of further non-limiting examples, the infrastructure-feature 16 may be a traffic-signal 52, a roadway-sign 54, or a street-light 56. The controller 32 may be configured to determine an operational-state 62 of, for example, the traffic-signal 52 and/or the street-light 56, and issue a need-for-maintenance 30 if either is found to be out of operation. Similar to detecting the quality of the lane-marking 24, signals or information from the imaging-device 14 may be used to determine the reflectivity and/or apparent contrast of the roadway-sign 54, and issue a need-for-maintenance 30 if the roadway-sign is difficult for the imaging-device to read or detect. If an instance of the infrastructure-feature 16 has been removed because of, for example, the presence of a construction-zone 64 so that the infrastructure-feature 16 is characterized as not-detected 66 by the system 10, the maintenance-organization 44 may receive a need-for-maintenance 30 but ignore it because the construction-zone 64 is very-temporary. If the construction-zone is expected to be present for a relatively long time, more than a week, then the maintenance-organization may elect to update the map-database 50 to stop the issuance of the need-for-maintenance 30 from the host-vehicle 12.

Accordingly, a roadway-infrastructure-maintenance system (the system 10), a controller 32 for the system 10 and a method of operating the system 10 is provided. The system 10 advantageously makes use of various imaging devices available on automated-vehicles to more quickly detect when the need-for-maintenance of an infrastructure-feature 16 is needed.

While this invention has been described in terms of the preferred embodiments thereof, it is not intended to be so limited, but rather only to the extent set forth in the claims that follow.

We claim:

1. A roadway-infrastructure-maintenance system using automated-vehicles to maintain a roadway, said system comprising:
an imaging-device suitable to mount on a host-vehicle, said imaging-device used to detect an infrastructure-feature proximate to a roadway traveled by the host-vehicle; and
a controller in communication with the imaging-device, said controller configured to determine a need-for-maintenance of the infrastructure-feature.

2. The system in accordance with claim 1, wherein the system includes a digital-map that indicates an expected-presence of the infrastructure-feature, and the need-for-maintenance is indicated when the infrastructure-feature is not-detected as expected.

3. The system in accordance with claim 1, wherein the system includes a transmitter in communication with the controller, said transmitter used to communicate the need-for-maintenance to a maintenance-organization.

4. The system in accordance with claim 1, wherein the imaging-device includes one of a camera, a radar-unit, and a lidar-unit.

5. The system in accordance with claim 1, wherein the infrastructure-feature includes one of a lane-marking, a traffic-signal, a roadway-sign, and a street-light.

6. The system in accordance with claim 1, wherein the host-vehicle is characterized as an automated-taxi.
